(19) United States
(12) Patent Application Publication
(10) Pub. No.: US 2019/0247769 A1
(43) Pub. Date: Aug. 15, 2019

(54) Fiber Chromatography

(71) Applicant: Chemtor, LP., San Marcos, TX (US)

(72) Inventor: John Lee Massingill, San Marcos, TX (US)

(21) Appl. No.: 16/277,501

(22) Filed: Feb. 15, 2019

Related U.S. Application Data
(60) Provisional application No. 62/630,967, filed on Feb. 15, 2018.

(51) Int. Cl. B01D 15/22; B01D 15/14; B01D 15/18

(52) U.S. Cl. CPC B01D 15/22; B01D 15/1807; B01D 15/14

(57) ABSTRACT

Chromatographic processes are provided which utilize fiber conduit contactors to effect separation of chemical substances from a mixture. In particular, processes are provided which constrain a substance on the fibers and move a mixture of chemical substances and another fluid through the coated fibers to effect separation of a substance from the mixture. In addition, fiber conduit contactors configured to affect such processes are disclosed. Some apparatuses include a sample injection mechanism for selectively inserting an analytical or preparative chromatography mixture into a fluid being supplied to the conduit. Additional or alternative apparatuses include fibers positioned longitudinally within a conduit with their opposing ends respectively bundled into a fluid inlet and a fluid outlet at opposing ends of the conduit. The portions of the fibers between the bundled ends are sufficiently slack such that larger spaces exist between individual fibers along the slack portions than at the bundled ends.

The present application claims priority to U.S. Provisional Patent Application No. 62/630,967 filed Feb. 15, 2018.

### BACKGROUND OF THE INVENTION

### 1. Field of the Invention

This invention generally relates to fiber conduit contactors and processes employing such devices, and specifically relates to fiber conduit contactors and methods for performing chromatographic processes.

### 2. Description of the Related Art

The following descriptions and examples are not admitted to be prior art by virtue of their inclusion within this section.

Chromatography in all its forms is the mainstay of the chemical enterprise. It is used to perform analytical separations of inorganic elements, natural products, synthetic organic compounds, pharmaceutical compounds and formulations, consumer product formulations, gases and volatiles, and polymeric materials in widespread industries. It is also used to perform preparative and process separations. Many chromatographic processes are effective for small batch analytical evaluation, but are difficult to scale up for large industrial applications. On the other hand, chromatographic processes which are suitable for large industrial applications typically require multiple steps and equipment which makes them costly and time consuming.

Accordingly, it would be desirable to develop different systems and methods for performing chromatographic processes.

### SUMMARY OF THE INVENTION

Processes are provided which utilize fiber conduit contactors to effect separation of chemical substances from a mixture, specifically via chromatographic processes. In particular, processes are provided which constrain a substance on the fibers and move a mixture of chemical substances and another fluid along the coated fibers to effect separation of a substance from the mixture. In addition, fiber conduit contactors configured to affect such processes are disclosed.

Embodiments of methods for conducting chromatographic separations include introducing a first fluid onto exterior surfaces of a plurality of fibers arranged longitudinally between opposing ends of a conduit such that at least some components of the first fluid constitute a phase substantially constrained to the exterior surfaces of the plurality fibers. In addition, the methods include introducing a second fluid into the conduit proximate the plurality of fibers such that the second fluid constitutes a phase flowing in alignment and between the plurality of fibers with the constrained phase thereon, wherein the flowing phase is immiscible with the constrained phase. Moreover, the methods include introducing a mixture of chemical substances into the conduit proximate the plurality fibers subsequent to introducing the second fluid into the conduit and while continuing to supply the second fluid into the conduit. The chemical substances have different distribution coefficients relative to the constrained phase and the flowing phase. As a result, the flowing phase moves the chemical substances of the mixture along the constrained phase of the plurality of fibers at respectively different speeds. The methods additionally include routing the flowing phase from the conduit to a chromatography detector.

Embodiments of apparatuses include a conduit with a fluid inlet proximate one end of the conduit and one fluid outlet proximate an opposing end of the conduit. The apparatuses further include a supply pipe coupled to the fluid inlet and a sample injection mechanism operatively associated with the supply pipe for selectively inserting an analytical or preparative chromatography mixture into a fluid in the supply pipe. Moreover, the apparatuses include a collection chamber positioned proximate the fluid outlet of the conduit and a plurality of fibers positioned longitudinally within the conduit and extending into the collection chamber.

Embodiments of other apparatuses include a conduit with two fluid inlets respectively arranged proximate opposing ends of the conduit and two fluid outlets respectively arranged proximate the opposing ends of the conduit. The apparatuses further include a plurality of fibers positioned longitudinally within the conduit such that opposing ends of the plurality of fibers are respectively proximate the opposing ends of the conduit, wherein the opposing ends of the plurality of fibers are respectively bundled into one of the fluid inlets and one of the fluid outlets. The portions of plurality of fibers between the opposing bundled ends are sufficiently slack such that larger spaces exist between individual fibers along the portions of the plurality of fibers than spaces between the individual fibers at the opposing bundled ends.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an example of a co-current fiber conduit contactor useful for the processes described herein;

FIG. 2 depicts an example of another fiber conduit reactor system useful for the processes described herein; and

FIG. 3 depicts an example of a counter-current fiber conduit reactor system useful for the processes described herein.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

The disclosure herein relates generally to methods and devices to affect separation of solutes from a mixture of solutes and, specifically chromatographic processes, in fiber conduit contactors, for different scales of separation ranging up to large scale industrial separations. As explained in more detail below, the disclosed methods and devices combine the advantages of liquid column chromatography, countercurrent chromatography, and other chromatography variants. In general, the disclosed methods and devices include a fiber conduit contactor filled with fibers having a sheath of constrained solvent along their exterior surfaces that acts to partition solutes in a stream that is passed in between the fibers. The methods and devices disclosed herein can be employed at or under room temperature and at or near atmospheric pressure, avoiding the need for expensive high pressure systems. For some processes (e.g., super critical solvent separations), however, the methods and devices disclosed herein can be employed above room temperature and/or significantly above atmospheric pressure. A benefit of the methods and devices described herein is that the fiber conduit contactors may be made from off the shelf commercial materials without the need for sophisticated precise engineering. They are very robust in operation.

It is to be understood that the methods and devices disclosed herein is not limited to particular compositions of fiber, mobile phase, constrained phase or mixture of solutes employed in the examples, which may vary. It is also to be understood that the terminology used herein is for the purpose of describing particular embodiments only, and is not intended to be limiting. In addition, when examples are given, they are intended to be exemplary only and not to be restrictive. It is noted that, as used in this specification and the appended claims, the singular forms “a,” “an” and “the” include plural referents unless the context clearly dictates otherwise.

The methods and apparatuses disclosed herein may generally be used for any analytical or preparative chromatography needs. “Analytical chromatography” as used herein refers to processes of using chromatography to identify and perform qualitative and quantitative analysis of one or more compounds in the sample mixture. “Preparative chromatography” as used herein refers to processes of using chromatography to isolate one or more compounds from a sample mixture at a purity level sufficient for further experiments, processes, or marketing. Examples of compounds which may be separated from a sample mixture for analytical and preparative chromatography processes using the methods and apparatuses disclosed may include but are not limited to ionizable analytes such as but not limited to metal salts, phenols, carboxylic acids, amino acids, peptides, proteins, enzymes, as well as pharmaceuticals, specialty chemicals, neutraceuticals, fatty acids, amines, and neutral organic molecules. Moreover, chromatographic resolution of the methods disclosed herein is enhanced through the reduction of mobile-phase dead volume in the column. In view of this, the methods disclosed herein are well suited to a variety of purification problems, e.g., separation of chemical ingredients in pharmaceuticals, medicinal herbs, organic synthetic product mixtures, and rare earth mixtures. Furthermore, because of its avoidance of adsorptive losses of solutes and contamination by solid matrix materials in the course of separation, the methods disclosed herein can be applied to the purification of even chemical constituents that are present in relatively low quantities in a mixture, such as less than 1%.

Analytical and preparative separations may involve the separation of a variety of substances, such as but not limited to specialty organic chemicals, active pharmaceutical ingredients (API), API intermediates, amino acids, peptides, enzymes, proteins, antibiotics, lipids, phospholipids, agrochemicals, insecticides, vitamins, organic acids, amines, sugars and derivatives, medicinal plant extracts such as neutraceuticals, cannabinoids, flavonoids, catechins, alkaloids, anthraquinones, ligands, dyes and pigments, others, and inorganic elements such as base metals, technology metals, rare earths, and heavy metals. With asymmetric constrained phase constituents, enantiomeric separations can be made. Protein separations can be achieved with aqueous two phase systems. Essentially, anything that can be separated by known chromatographic methods should be applicable to analytical or preparative scale operation using the devices disclosed herein. Specific separation processes that are contemplated include but are not limited to separation of rare earth metals, separation of hemp extract into CBD, CBDA, and other cannabinoids, separation of an API synthesis mixture, separation of proteins (antibodies and enzymes), separation of fatty acids from oils and/or fats, separation of phospholipids from oils or fats, separation of antibiotic mixtures, separation of neutrals from acidic solutes, separation of aliphatic from aromatic species and waste remediation.

As noted above, the methods disclosed herein generally include a fiber conduit contactor filled with fibers having a sheath of constrained solvent along their exterior surfaces that acts to partition solutes in a stream that is passed in between the fibers. The constrained phase and the passing phase generally and respectively act as the “stationary phase” and the “mobile phase” referenced in many conventional chromatography techniques. More specifically, the term “constrained phase”, as used herein, refers to a surface modification that has been placed on a fiber to serve as the “stationary phase” described in conventional chromatography theory. The term “flowing phase” as used herein refers to a fluidic phase that is made to flow in between the fibers having the constrained phase thereon to serve as the “mobile phase” described in conventional chromatography theory. The term “flowing phase” is synonymous herein with the terms “mobile phase” and “passing phase” and, thus, the terms may be used interchangeably herein.

In some cases, the constrained phase may be substantially immobilized on the fibers. The term “substantially immobilized” as used herein refers to a state in which a material does not flow as a whole, but yet portions of the material may be gradually or intermittently removed due to exposure of other elements, such as movement of the mobile phase along the constrained phase. In embodiments in which the constrained phase is substantially immobilized on the fibers, the phase may be a solid or a semi-solid (e.g., a gel). Furthermore, in such cases, the constrained phase may be formed on the fibers by introducing a fluid into the conduit to flow along the fibers and then allowing the solid or semi-solid material to form on the fibers from the fluid. The latter step may involve evaporating a vapor solvent in the fluid to evaporate or dissipate or may involve a separate curing or reaction step. In any case, the methods disclosed herein may, in some embodiments, include washing the fibers having a substantially immobilized constrained phase thereon prior to the introduction of a mobile phase into the conduit between the fibers. The washing process may generally involve introducing any fluid into the conduit which is not reactive with the constrained phase, such as but not limited to water.

In other embodiments, the constrained phase may be a liquid and, thus, may flow along the fibers during the chromatographic process. In some cases, the constrained phase may flow at a rate slower than the mobile phase. For example, in some embodiments, the constrained phase may very viscous and flow at a rate just enough to replenish any material lost to the mobile phase. In such instances, it may be beneficial to determine constrained phase retention in efforts to improve separation. In particular, when the peak resolution is unsatisfactory, a measure of the constrained phase retention will serve as a guide for the next trial. Separation may be varied by varying the flow rate of the mobile phase and/or constrained phase. In yet other embodiments, the constrained phase may flow at a rate closer to, equivalent or greater than the mobile phase. An example ratio of constrained phase flow to mobile phase flow may be 1:10 to 1:0.9, but larger or smaller ratios may be considered. In cases in which the constrained phase does flow during a chromatographic process, the term “co-current distribution”, as used herein, refers to a process in which the constrained phase and the mobile phase travel in the same direction. Conversely, the term “counter-current distribution”, as used herein, refers to a process in which the constrained phase and the mobile phase travel in the opposite direction.

Regardless of whether the constrained is immobilized or flows along the fibers, the constrained phase may include any material that wets the fibers preferentially to the mobile phase (i.e., has a polarity sufficient to retain the material on the fibers during chromatographic process) and is immiscible with the mobile phase. The term “immiscible”, as used herein, refers to substances that cannot be mixed to form a single phase. The retention of the constrained/stationary phase is accomplished by a combination of solvent-fiber hydrophilicity, surface tension, repulsion of the mobile phase, flowrate of the constrained phase, and flowrate of the mobile phase. Examples of constrained phases include but are not limited to water, water solutions, water and co-solvents, water and polymers, water and salts, water and ionic liquids, solvents and cosolvents, alcohols, phenols, aromatic hydrocarbons, aliphatic hydrocarbons, heterocyclic solvents, amines (including but not limited to, polyamines, ethanolamines, and polyethanolamines), polyglycols, carboxylic acids, dimethyl sulfoxide, dimethyl formamide, sulfuric acid, ionic liquids, and silica-based materials. In some cases, the constrained phase may be less polar than the mobile phase.

The mobile phase introduced between the fibers may be a liquid or a gas. In general, it is advantageous for the mobile phase to be of high purity, compatible with the detector, nonreactive with the sample. In some cases, buffers (acids or bases) may be added to a mobile phase material to control the degree of sample ionization and occupy free unreacted functional groups present in the constrained phase. Moreover, the mobile phase may be hydrophilic or hydrophobic, provided it is immiscible with the constrained phase (i.e., the mobile phase may be hydrophilic when the constrained phase is hydrophobic and, conversely, the mobile phase may be hydrophobic when the constrained phase is hydrophilic). For example, a steel fiber may be used with an aqueous/polar constrained phase with an organic/non-polar mobile phase of vice versa. Examples of mobile phases which may be used for the methods disclosed herein include but are not limited to water, acetonitrile, and/or methanol. Acetonitrile and methanol may be advantageous due to their low viscosity, high strength and UV favorability in the low wavelength range. In addition, acetonitrile and methanol may provide the best peak shape, are easy to evaporate after isolation, and tend to be nonreactive with most samples. In some embodiments, particularly for counter-current operations, the mobile phase may include fluids with a relatively high degree of polarity, such as but not limited to hexane-ethyl acetate-methanol-water or methylbutylether-n-butanol-acetonitrile-water. In some cases, such as but not limited to protein purification processes, both the mobile phase and constrained phase may be aqueous.

Mobile phase pH can be an important variable in the control of retention of analytes during a chromatographic process. Compounds often contain one or more acidic or basic functional groups therefore mobile phases require pH control. When an acid is more than 2 pH units above or below its pKa, it will be >99% ionized or unionized, respectively. In contrast, bases are ionized below their pKa and non-ionized above their pKa. The unionized form will be less polar (more hydrophobic), and thus more strongly retained. As a result, acids are better retained at low pH, whereas bases are better retained at high pH. If the mobile phase pH is near the pKa of the compound of interest, small changes in pH can make large changes in retention, which can directly impact the robustness of the separation. PH of the mobile phase is controlled by the addition of a buffer. The buffer maintains the pH when a small amount of acid or base is added. It is most effective when used within ±1 pH unit of its pKa, but may provide adequate buffering ±2 pH units from the pKa. When selecting a working pH, the stability of the column should also be considered.

In any case, the thickness of the constrained phrase and the mobile phase can generally range from approximately 1 nanometer to approximately 120 microns, and, in specific embodiments, between approximately 1 micron and approximately 50 microns. An advantage of the methods and apparatuses disclosed herein is that the constrained phase and mobile phases can be many times thicker than the phases used in conventional chromatography, resulting in significant increases in throughput for preparative chromatography. More specifically, the methods and apparatuses disclosed herein allow a greater amount of sample to be processed for a given amount of time due to greater thickness of the phases. In addition, in cases in which the fiber diameter are less than a micron, more fibers may be included for a given size of a conduit, resulting in greater surface area relative to conventional techniques, which further allows a greater amount of sample to be processed. Moreover, the thickness selected for the constrained phase will impact resolution of the chromatographic process. The thickness of a flowing constrained phase is determined by the flow rate of the phase through the column. For example, a ½″×12″ column with 8 micron fibers and a constrained phase flow rate of 1 mL/min would have a constrained phase thickness of 250 nm. At a flowrate of 4 mL/min, the film would be one micron thick. It is noted that the methods and devices disclosed herein are not limited to such column or fiber size or the flow rates of the constrained and mobile phase.

In methods disclosed herein, the flow rate of the mobile phase determines the separation time and peak resolution of the chemical substances separated from the chemical mixture. Higher mobile phase flowrates tend to drag the constrained phase through the column. Lower flow rates usually give higher retention level of the constrained phase improving the peak resolution although it requires a longer separation time. Typical mobile flowrates for the methods and devices disclosed herein may be between approximately 1 mL/min and approximately 50 ml/min. Specific examples of mobile flow rates for particular column sizes include approximately 5 mL/min for a ½″ i.d. (e.g., a 1 g sample load), approximately 25 ml/min for a 1″ i.d. column (e.g., a 5 g sample load); and approximately 6.4 L/min for a 16″ i.d. column (e.g., a 1 kg sample load), although slower and faster flow rates and smaller and larger columns may be considered irrespective of each other. In some embodiments, the rate the mobile phase is introduced into the conduit may be gradually or intermittently increased over a portion or during the entire chromatographic process. Such increases may increase the ability to separate solutes with a wide range of hydrophobicity in a reasonable time frame. Additional advantages may include improved peak resolution and increased sensitivity due to greater peak height.

In any case, the fibers may range from approximately 3 nanometers to approximately 150 microns in diameter depending on the application. In addition, the spacing between fibers may generally be with the same ranges. Stainless steel 316 and nichrome fibers are commercially available down to 1 micron in diameter. Glass fibers are commercially available down to 2 micron in diameter. Optical glass fibers are commercially available coated with plastics like acrylate, silicone or polyimide and doped with materials like rare earths. More than fifty different polymers have been successfully electrospun into ultrafine fibers with diameters ranging from <3 nm to over 1 μm. Vectra A Liquid Crystal Polyester Fiber with 23 micron diameter is commercially available. A conductive fiber of poly(L-lactic acid) (PLA) and polyaniline (PANI) has been made at 500 nanometer diameter for medical applications. Nanofibrillated Fibers with diameters of 100-500 nm are commercially available from Engineered Fibers Technology. They also have fibers of ethylene vinyl alcohol (EVOH), polyester/nylon, polyvinylalcohol, and polymelamine fibers. Carbon fibers of 5-10 micron diameter are available with and without various coatings. In any case, the fibers employed in the methods and devices disclosed herein are generally solid, but hollow fibers may be considered. In either case, the constrained phase is applied to an exterior surface of the fibers.

In some cases, it may be advantageous to employ relatively thin fibers and/or have thin spacing between the fibers. In particular, smaller spacings between the fibers will reduce the mobile phase dead volume in the conduit, resulting in less peak broadening. Furthermore, in co-current operations, it is theorized that diffusion of the solutes into the constrained phase will be less with thinner fibers, resulting in less peak broadening. In particular, thinner fibers will generally allow the mobile phase and, thus, the mixture of solutes to flow faster along the fibers deterring the rate of diffusion of the solutes into the constrained phase. On the contrary, relatively thick fibers may be advantageous in counter-current operations in order to enable the counter-current flow. An example thickness of “relatively thin” fibers may generally be those having a diameter of less than approximately 5 microns and, in particular embodiments, less than 1 micron in diameter. An example thickness of “relatively thick” fibers may generally be those having a diameter greater than approximately 5 microns and, in particularly embodiments, greater than approximately 50 microns and, in some cases, greater than approximately 125 microns.

In general, the fibers may include, but are not limited to, natural fibers such as cotton, jute, silk, hemp, treated or untreated; minerals, metals, metal alloys, treated and untreated; carbon, treated and untreated; polymers, polymer blends, and combinations thereof, treated and untreated. Suitable treated or untreated minerals include, but are not limited to, glass, asbestos, ceramic, basalt, and combinations thereof. Suitable metals include, but are not limited to, steel, nickel, copper, brass, lead, tin, zinc, cobalt, titanium, tungsten, nichrome, silver, gold, aluminum, and alloys thereof. Suitable polymers include, but are not limited to, hydrophilic polymers, polar polymers, hydrophilic copolymers, polar copolymers, and combinations thereof, such as polysaccharides, polypeptides, polyacrylic acid, polymethacrylic acid, functionalized polystyrene (including but limited to, sulfonated polystyrene and aminated polystyrene), nylon, polybenzimidazole, polyvinylidenedinitrile, polyvinylidene chloride, polyphenylene sulfide, polymelamine, polynovolac, sulfonated polynovolac, polyvinyl chloride, co-polyethylene-acrylic acid and ethylene-vinyl alcohol copolymers. The fibers can be treated for wetting with preferred phases and to protect from corrosion by the process streams. For instance, carbon fibers can be oxidized to improve wettability in aqueous streams and polymers can display improved wettability in aqueous streams by incorporation of sufficient functionality into the polymer, including but not limited to, hydroxyl, amino, acid, or ether functionalities. In any case, the fibers can be straight, randomly directional, multilobed and/or filibrated.

The methods and devices disclosed herein can be employed at or under room temperature and at or near atmospheric pressure, avoiding the need for expensive high pressure systems. For some processes (e.g., super critical solvent separations), however, the methods and devices disclosed herein can be employed above room temperature and/or significantly above atmospheric pressure, such as but not limited to approximately 50 psig to approximately several hundred psig.

Selection of phases and operating parameters for a chromatographic separation of a mixture of chemical substances are based on distribution coefficients of the chemical substances. Distribution coefficient (K) is the ratio of chemical substance distributed between the mutually equilibrated two solvent phases. It may be expressed by the amount of solute in the constrained phase divided by that of the mobile phase as is similarly done in conventional liquid chromatography. Chromatographic separation of different chemical substances having dissimilar distribution coefficients toward a pair of immiscible mobile phase and constrained phase is brought about by the equilibrations of the solutes between the nano- and micro-streams of these two phases. As a result, a chemical substance with a distribution coefficient that favors its dissolving in the constrained phase will be retarded in its migration through the column compared to a solute with a distribution coefficient that favors its dissolving in the mobile phase. Consequently, the mobile phase moves the chemical substances along the constrained phase at respectively different speeds.

Preparation of the mixture of chemical substances to be separated for the methods disclosed herein needs some consideration. After a hydrodynamic equilibrium is established between the constrained phase and the mobile phase, the mixture may be injected with the mobile phase or the constrained phase when the constrained phase is flowing. Alternatively, the mixture may be mixed with the fluids used to form the mobile phase and constrained phase prior to being introduced into the conduit and then injected into the conduit. Starting volume of the mixture for the methods disclosed herein may be less than 5% of the total column capacity. Introduction of a larger mixture volume into the column may reduce peak resolution of the analytes especially with those having small K values. Ideally an analyte is injected in a small volume of the constrained phase to preserve the sharpness of the early elution peak, since the mobile phase then further concentrates the analyte in the sample compartment in the column. When a sample contains solutes with a broad range of hydrophobicity, one can minimize the necessary sample volume by dissolving it into a mixture of two phases (by dissolving hydrophobic components into the organic phase and polar components into the aqueous phase).

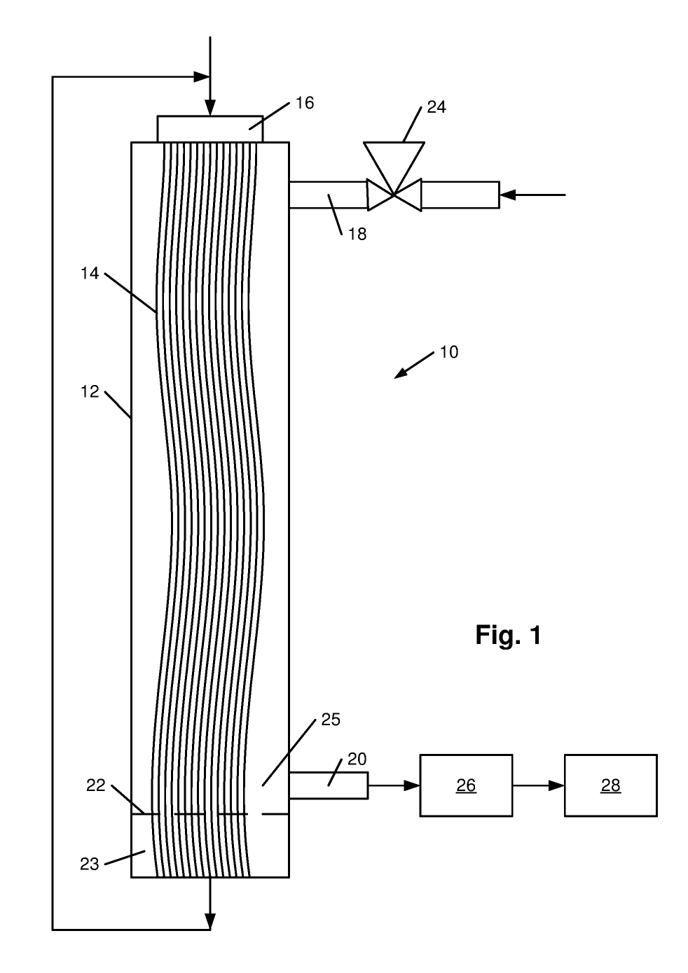

The methods and devices disclosed herein uses an efficient design which consists of a plurality of fibers contained in a conduit. Example inner diameter ranges of conduits for the methods and devices disclosed herein may be ≤½″ i.d. for analytical scale applications, >½″ to 2″ i.d. (and in some embodiments, particularly 1″ i.d.) for semi-preparative scale applications and >2″ i.d. for preparative scale applications. Conduits having smaller or larger inner diameters, however, may be considered. The conduit of the devices disclosed herein can be any desired length since the system operates at low pressure. Furthermore, although the fiber conduit contactors shown and described in reference to FIGS. 1-3 arranged such that fluid flow traverses in a vertical manner, the arrangement of the fiber conduit contactor is not so limited. In particular, the fiber conduit contactors considered may alternatively be arranged for fluid flow to traverse in a horizontal manner or at any angle between 0° and 90° relative to a floor of a room in which the fiber conduit contactor is arranged.

An example of a conduit contactor used for the methods disclosed herein may include a column having an inner diameter of approximately 4 inches and a length of approximately 12 inches. Using such a device, a constrained phase having a comparable film volume of 64 mL with a one micron film constrained to the fibers may be used at a pressure of approximately 5 psig. Column size, however, may vary depending on the specifications of the process. For example, a column of up to approximately 10 feet wide by any length desired may be used. For comparison, a common process preparative HPLC column is typically 3 inches in diameter and 10 inches in length. The surface area of commercial preparative HPLC column packing material is typically 400 m²/gram and particle size is typically 5-15 microns. Carbon loading on the particles is typically 20% of the surface area and film thickness is about 1 nanometer, so the volume of absorbent layer is about 100 mL. Column sample size is typically 1-200 grams of solute. Column pressure is typically about 500 psig.

A method of separating a mixture of chemical substances using a fiber conduit contactor/column is provided. The system comprises a chromatographic separation column containing a liquid phase constrained to fibers filling the tube and a method of introducing the constrained phase to the fiber bundle and introducing the mobile phase between the wetted fibers. The constrained phase has a polarity sufficient to retain the phase material on the fibers in the column during the chromatographic process and is immiscible with the liquid mobile phase. As the mobile phase is introduced in the conduit and its solvent front emerges from an opposing end of the conduit, excess constrained phase may be pushed out when the mobile phase fills the void space between fibers. A hydrodynamic equilibrium is then established between the mobile phase and the constrained phase, which may be determined empirically by viewing the effluent of the conduit or may be determined by measuring the concentration of the mobile phase and/or the constrained phase at the effluent of the conduit.

After such establishing a hydrodynamic equilibrium between the mobile phase and the constrained phase, chromatographic processing may start with the injection of a mixture of chemical substances into the conduit, wherein each of the chemical substances travels between the wetted fibers in the chromatographic separation column at a rate determined by the distribution coefficients of the chemical substances between the mobile and constrained phases. The system will run consistently in this manner as long as the flowrates of the mobile phase and mixture of chemical substances and, if applicable, the constrained phase are maintained. Alternatively, one can use an injection valve with a sample loop to inject a succession of mixtures of chemical substance at suitable intervals without renewing the column contents. This may be particularly useful for determination of log P values of various drugs.

The liquid mobile phase flows from an outlet port of the conduit to a receiver where any constrained phase carry over and the mobile phase are instantaneously separated. This will give a clear tracing of the elution curve because of the minimum carryover of the constrained phase with the mobile phase from the column. Moreover, the method includes eluting the solutes in the liquid mobile phase from the chromatographic separation column into the receiver to separate the solutes from the mixture. The effluent mobile phase from the outlet of the column may be continuously monitored by a chromatography detector. There is no carryover in the method disclosed herein so the constrained phase does not disturb the tracing of the elution curve. Furthermore, formation of bubbles which might be trapped in the flow cell and disturb the tracing of the elution curve is not generally a problem with the method disclosed herein. For analytes without chromophores, on-line monitoring of the effluent can be performed by various ways, e.g., using evaporative light scattering detector, mass spectrometry, infrared, ultraviolet light, refractive index, or pH. Although on-line is recommended, it is not necessary if one has optimized the solvent system so that the target compound elutes after a reasonable volume predicated by its K value. After collecting fractions of the chemical substances, one can evaluate them by HPLC or TLC combined with densitometry.

After the solvent composition is determined, the retainer (typical concentration of 10-20 mM) is added to the constrained phase and the eluter (about equal molar concentration to the retainer) is added to the mobile phase. The concentration of eluter in the mobile phase mainly determines the concentration of analyte in the eluted fractions. Therefore, increasing the eluter concentration results in a higher concentration and shorter retention time of the analyte. On the other hand, the concentration of the retainer in the constrained phase determines the concentration of analyte in the stationary phase within the column. Consequently, increasing the constrained phase concentration raises the concentration of analytes in the stationary phase associated with a longer retention time or increased K value of the analyte.

In general, a large amount of sample can be effectively separated by applying high concentrations of both retainer and eluter, e.g., 40 mM each. However, use of such high retainer concentration often induces carryover of the constrained phase, apparently caused by precipitation of the analyte due to its excessively high concentration or limited solubility in the constrained phase. An alternative approach is the art with equal but smaller molar concentrations of retainer and eluter such as 10-20 mM each. The method allows the use of an organic phase as the mobile phase (in this case, the retainer becomes the eluter and vice versa). In this operation, the retainer in the aqueous constrained phase serves as the counter-ion for the retained analytes to determine their concentration in the constrained phase. The eluter in the organic phase, on the other hand, modifies the partition coefficient of analytes in such a way that increasing the eluter concentration shortens the retention time and increases the concentration of analyte in the mobile organic phase. In this mode, 10-20 mM each of the eluter and retainer may also produce a satisfactory result.

The different migration rates of different solutes bring about their chromatographic separation on within the conduit, effectively combining the advantages of countercurrent distribution, liquid column chromatography, and dispersed mobile-phase countercurrent chromatography. In particular, a separation process that is in a continuous mode of operation within single conduit reactor/contactor with co-current flow is produced, which is scalable from analytical to large industrial separations without any centrifugal or mechanical steps. Thus, the methods described herein differ from the countercurrent distribution (CCD) and controlled-cycle pulsed liquid-liquid chromatography (CPLC) methods which require discontinuous countercurrent flow of one immiscible phase past another immiscible phase, interrupted by pauses for the performance of solute equilibrations between the two phases.

The methods disclosed herein are also different than the droplet countercurrent chromatography (DMCC) method which requires multiple columns and dispersion settling time, which restricts severely the total separation volume of the system. In contrast, with the methods and devices disclosed herein, there are no constraints on the size of the conduit reactor/contactor and only one conduit reactor/contactor is needed. Furthermore, there is practically no settling time needed for the methods disclosed herein (i.e., less than a few seconds) and, thus, the volume of the constrained phase allowed for the processes disclosed herein readily allows large industrial scale separations of solutes. Moreover, the methods disclosed herein do not require centrifugation to speed up equilibration of the nano- and micro-mobile and constrained phases and, therefore, the methods disclosed herein differ from the centrifugal partition chromatography (CPC), high speed countercurrent chromatography (HSCCC) and high performance countercurrent chromatography (HPCCC) methods.

Turning to the drawings, FIG. 1 shows an example of a fiber conduit contactor 10 which may be used for co-current chromatography processes or, alternatively, chromatography processes in which the constrained phase is substantially immobilized on the fibers. In any case, the constrained phase is introduced into the conduit 12 through inlet port 16 to wet the fibers 14 in the conduit. In general, inlet port 16 may be proximate one end of conduit 12. In some cases, inlet port 16 may be a fluid inlet arranged very near the end of the conduit as shown in FIG. 1. In other cases, inlet port 16 may include a tube extending into the conduit and also include a perforated node at the end of the tube to which fibers 14 are attached. In either case, the mobile phase is introduced along the wetted fiber bundle through inlet port 18. Upon entry into the column, the mobile phase is squeezed between the wetted fibers to a thickness of approximately 1 nanometer to approximately 120 microns. The sample mixture may be injected into conduit 12 through an injection sample loop valve 24 attached to port 18. After passing through the column, any overflow constrained phase collects in receiver chamber 23 below the interface 22 at the end of the fiber bundle. The receiver chamber may be part of conduit 12 as shown in FIG. 1 or alternatively may be a separate vessel proximate to the outlet of conduit 12. Note that the fibers pass through the interface 22. This prevents carryover of small droplets coming off the fibers in the mobile phase.

The constrained phase discharged out from conduit 12 can be recycled to inlet port 16 at a rate that keeps the interface 22 steady. This prevents wasting constrained phase. If the interface holds steady, the constrained phase transfer pumps may be run intermittently as needed. Mobile phase from the conduit collects in receiver chamber 25 above the interface 22. Receiver chamber 25 may be a section of conduit 12 proximate its opposing end as shown in FIG. 1 or it may be a separate vessel arranged exterior to the column proximate its opposing end. In either embodiment, it may be advantageous for the receiver chamber to be relatively small (i.e., approximately 1 to approximately 100 mL) to prevent the separated compounds from diffusing back together. In any case, the portions of the mobile phase collected in the receiver may be routed to chromatography detector 26 as shown in FIG. 1.

In some cases, the fluid may be further transported to fraction collector 28 after passing through chromatography detector 26, but the use of a fraction collector is optional. In particular, use of a fraction collector may only be applicable for preparative chromatography processes. More specifically, the function of the fraction collector is to divert separated solute rich fractions to receiving vessels. In some cases, a portion of the collected mobile phase can be recycled back to inlet port 18 and/or a portion or all of the constrained phase may be recycled back to inlet 16. In some cases, a portion of the mixture of chemical substances may be recycled back through sample injection mechanism 24. In any case, the fiber conduit contactor 10 can also be operated in the inverse direction in some embodiments. In some cases, fiber conduit contactor 10 may include a heat transfer means operatively associated with the conduit whereby thermal energy may be transferred to or from conduit 12. In particular, some processes described herein may need to be heated or cooled, particularly those involving a gas stream and/or viscous liquid/s.

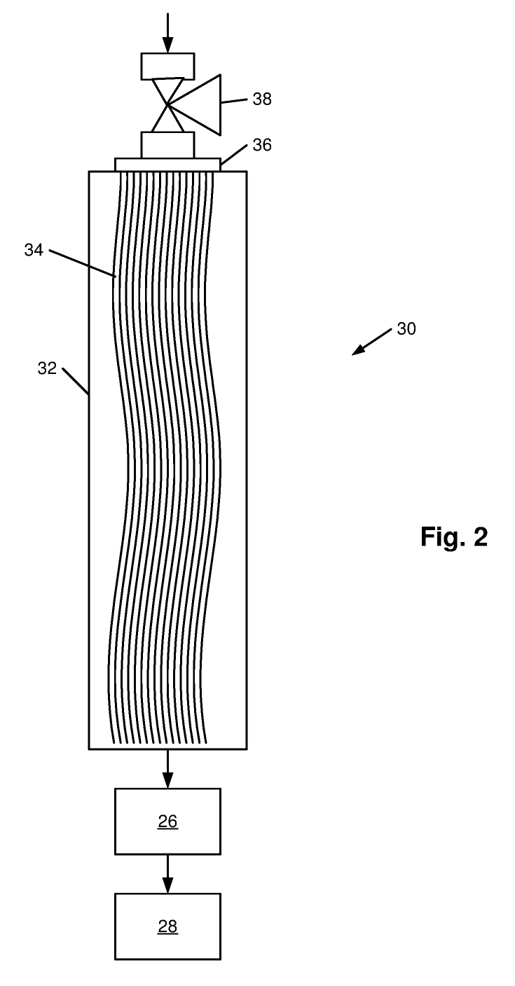

FIG. 2 shows an example of a fiber conduit contactor 30 which may be used for chromatography processes in which the constrained phase is substantially immobilized on the fibers 34. With the configuration of this apparatus, the constrained phase and the mobile phase are successively introduced into conduit 32 through same inlet, specifically inlet port 36. In particular, the constrained phase comprising a species that coats and/or reacts with the surface of the fibers to make constrained phase that is substantially immobilized on the fibers. After the constrained phase is prepared on the fibers and optionally washed, the mobile phase is introduced to the coated fiber bundle through inlet port 36. Upon entry into the column, the mobile phase is squeezed between the coated fibers to a thickness of approximately 1 nanometer to approximately 120 microns. Then, the sample mixture is injected into the conduit 32 through injection sample injection mechanism 38 attached to port 36. The mobile phase from conduit 12 is transported through the chromatography detector 26 and optionally to a fraction collector 28. The fraction collector may receive the mobile phase and divert separated solute rich fractions to receiving vessels.

In some cases, fiber conduit contactor 30 may include a heat transfer means operatively associated with the conduit whereby thermal energy may be transferred to or from conduit 32. In particular, the processes described herein may need to be heated or cooled, particularly those involving a gas stream and/or viscous liquid/s. In addition, the fiber conduit contactor shown in FIG. 2 may, in some cases, be configured to recycle the mobile phase and/or the mixture of chemical substances as discussed in reference to the fiber conduit contactor shown in FIG. 1. In any case, fiber conduit contactor 30 can also be operated in the inverse direction in some embodiments.

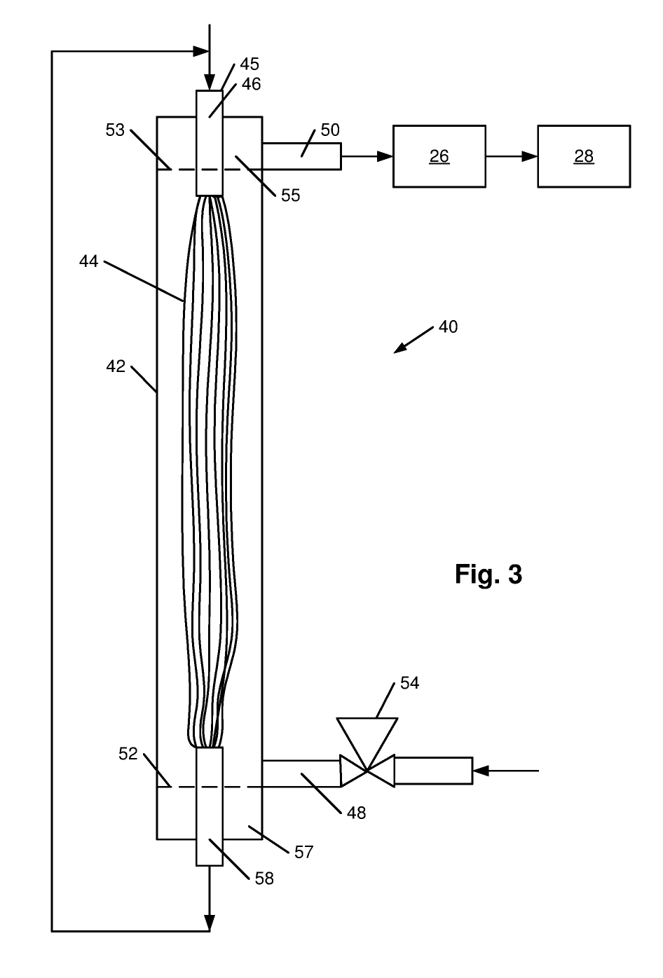

FIG. 3 shows an example of a fiber conduit contactor 40 which may be used for counter-current chromatography processes or, alternatively, chromatography processes in which the constrained phase is substantially immobilized on the fibers 44. In embodiments in which fiber conduit contactor 40 is used for counter-current chromatography processes, two interfaces of the constrained phase and the mobile phase are maintained proximate opposing ends of the conduit as is illustrated by references numbers 52 and 53 in FIG. 3. The constrained phase is introduced into the conduit 42 through inlet port 45 to wet the fibers in tightly packed inlet tube 46 at the top of the column. This tube extends into the conduit, passes into the collection chamber 55, and below the area at which upper interface 53 of the constrained phase and the mobile phase will be maintained during operation. The opposing ends of fibers 44 are bundled into outlet tube 58 at the opposing end of conduit 42. Outlet tube 58 extends below the area at which lower interface 52 of the constrained phase and the mobile phase will be maintained during operation. In addition, outlet tube 58 extends out of conduit 42, serving as an outlet for the constrained phase in embodiments in which the constrained phase flows along the fibers during the chromatography process. The portions of the fibers between inlet tube 46 and outlet tube 58 in conduit 42 are unbounded and sufficiently slack such that larger spaces exist between individual fibers along the portions of the plurality of fibers than spaces between the individual fibers within tubes 46 and 58.

The mobile phase is introduced along the wetted fiber bundle through inlet port 48 above lower interface 52. Upon entry into the column, the mobile phase is squeezed between the wetted fibers to a thickness of tens to hundreds of microns. It is noted that the thickness of the mobile phase is greater than 10 microns since fiber spacing of greater than 10 microns is generally needed to facilitate counter-current flow. The sample mixture is injected into conduit 42 through an injection sample mechanism 54 attached to port 48. After passing through the column, constrained phase removed from fibers 44 collects in collection chamber 57 below the interface 52 at the end of conduit 42. Note that outlet tube 58 pass through interface 52. After passing up through the column, mobile phase collects in collection chamber 55 the upper interface 53 and flows to chromatography detector 26. Similar to the apparatuses of FIGS. 1 and 2, the apparatus of FIG. 3 can also be operated in the inverse direction in some embodiments.

PH-zone-refining conventional counter-current chromatography is generally employed as a large-scale preparative technique for separating ionizable analytes such as salts, metal salts, REE salts, phenols, carboxylic acids, amines, amino acids, and peptides. The method elutes highly concentrated rectangular peaks fused together with minimum overlapping while impurities are concentrated and eluted between the outside the major peaks according to their pKa and hydrophobicity. The greatest advantage of the method is its large sample loading capacity. In addition, the method provides various special features such as yielding highly concentrated fractions, concentrating minor impurities for detection, and allowing the separation to be monitored by the pH of the effluent when there are no chromophores.

An example of inducing pH-zone-refining in the methods disclosed herein may involve loading a stationary phase comprised of H₂O/NH₄OH into a column of a fiber conduit contactor and then pumping a mobile phase of ether/H₃PO₄ with three acidic analytes, S1, S2, S3 through the column. The retainer acid, TFA, forms a sharp trailing border (due to its non-linear isotherm), which moves through the column at a rate lower than that of the mobile phase. The three analytes, S1, S2 and S3, competitively form solute zones behind the sharp TFA border according to their pKa and hydrophobicity. Among these, S1, with the lowest pKa and hydrophobicity is located immediately behind the H₃PO₄ border, while S3, with the highest pKa and hydrophobicity is located at the end of the solute zones where it forms a sharp trailing border. Proton transfer takes place at each zone boundary governed by the difference in pH between the neighboring zones. The loss of the solute from the mobile phase to the stationary phase is compensated by its return at the back of each zone while the ammonium ion in the aqueous phase serves as a counter-ion for all species. After equilibrium is reached, the three solute zones move at the same rate as that of the H₃PO₄ border, while constantly maintaining their width and pH. Charged minor components present in each zone are efficiently eliminated either forward or backward according to their partition coefficients (pKa and hydrophobicity) and eventually accumulate at the zone boundaries. Consequently, the three analytes elute as a train of rectangular peaks with sharp impurity peaks at their narrow boundaries.

The methods and devices disclosed herein provide a unique combination of extremely high mass transfer between two moving phases within a continuous column chromatographic set-up for solute separations. The important advantages of the methods and devices are two-fold: (a) the method does not require the use of any solid chromatographic matrix, and therefore avoids changes in performance with age, column pressure buildup, losses of solutes to irreversible adsorption to solid matrix, and contamination of the solutes by substances leached from the matrix; and (b) the distribution of any solute between two immiscible liquid phases is governed by, and largely predictable from, the distribution coefficient of the solute for the two liquid phases. The mechanical operation of the original CCD process, requiring a continual shifting of the upper and lower phases of neighboring tubes in a large battery of tubes followed by re-equilibration of the phases is cumbersome. In contrast, liquid column chromatography is widely employed because of its convenience, but requires the usage of solid matrices. The methods disclosed herein, thus, incorporate the advantages of CCD together with the convenient format of liquid chromatography freed of solid matrices. Because the fiber chromatography methods disclosed herein can be scaled up by increasing the internal diameter of the tube while maintaining fiber density without invoking any centrifugation, it is applicable to analytical separations, and also large scale industrial separations without incurring expensive equipment costs. Accordingly, the continuous fiber chromatography processes disclosed herein incorporate both the advantages of CCD and the convenience of liquid column chromatography.

The operation of methods disclosed herein is continuous in nature, employs a column with unrestricted dimensions and numbers of fibers, and does not require centrifugation. Therefore the methods are applicable to different scales of separations. The principle of methods disclosed herein is based on our discovery that, when a stream of liquid mobile-phase flows between fibers wetted with liquid stationary phase that is immiscible with the mobile phase, equilibrations of various solutes between the mobile and stationary phases will be facilitated because of the high interfacial contact of the films, thereby causing different solutes to migrate through the films of stationary phase at different rates owing to their dissimilar distribution coefficients between the two phases, and hence enabling chromatographic separation of the solutes. The total volume in the devices used for the methods disclosed herein can be made to exceed the readily attainable volume in CCD and its modifications without any requirement for centrifugation to speed up phase equilibration. The number of fibers employed can also be increased practically without limit, thereby vastly enhancing the total separation capacity of the devices disclosed herein at low equipment cost. The column system can also be built, assembled and taken apart readily using commercially available conventional tubing, fibers, mobile phases, stationary phases, and associated equipment such as pumps.

In the methods disclosed herein, an influx of mobile phase into a column of fibers coated with stationary phase does not need to be dispersed by mechanical means. The stream of mobile phase can travel through the fibers coated with stationary phase in the column in either the upward or downward direction. The chromatographic system can be scaled up by increasing the diameter and length of the column and number of fibers holding stationary phase. Furthermore, different fractionated solutes can be collected at different times from the effluent stream of the mobile phase exiting from the system. Moreover, the methods disclosed herein can employ an organic phase as mobile phase and an aqueous phase as constrained phase or vice versa. In addition, because the methods disclosed herein do not call for any volume restriction in its operation, does not use multiple columns, and does not require expensive equipment such as centrifugal devices, it can be scaled up readily for large scale industrial separations at relatively modest cost.

In general, the key advantages of methods and devices disclosed herein are co-current flow, counter-current flow, no centrifuge, no special extraction cells, no solid adsorbent, reduction of downstream steps, increased yield, increased profitability, increased cost-effectiveness, technical grade solvents, less solvent use, approximately 95% recyclable, no irreversible absorption, protein friendly solvents available, cGMP cleaning possible, disposable for potent API, and no down time between turn arounds. Although the methods disclosed herein emphasize liquid-liquid chromatographic processes, the devices disclosed herein may be used for gas chromatographic processes or liquid-solid chromatographic processes.

Methods for conducting chromatographic separations are provided which include introducing a first fluid onto exterior surfaces of a plurality of fibers arranged longitudinally between opposing ends of a conduit such that at least some components of the first fluid constitute a phase substantially constrained to the exterior surfaces of the plurality fibers. In addition, the methods include introducing a second fluid into the conduit proximate the plurality of fibers such that the second fluid constitutes a phase flowing in alignment and between the plurality of fibers with the constrained phase thereon, wherein the flowing phase is immiscible with the constrained phase. Moreover, the methods include introducing a mixture of chemical substances into the conduit proximate the plurality fibers subsequent to introducing the second fluid into the conduit and while continuing to supply the second fluid into the conduit. The chemical substances have different distribution coefficients relative to the constrained phase and the flowing phase. As a result, the flowing phase moves the chemical substances of the mixture along the constrained phase of the plurality of fibers at respectively different speeds. The methods additionally include routing the flowing phase from the conduit to a chromatography detector. In some cases, the methods include establishing a hydrodynamic equilibrium between the constrained phase and the flowing phase prior to introducing the mixture of chemical substances into the conduit.

In some cases, the step of introducing the mixture of chemical substances into the conduit comprises injecting the mixture of chemical substances into a fluid inlet supplying the second fluid into the conduit. In other embodiments, the step of introducing the mixture of chemical substances into the conduit comprises injecting the mixture of chemical substances into a fluid inlet supplying the first fluid into the conduit. In some cases, the constrained phase flows along the plurality of fibers. In such embodiments, the step of introducing the second fluid into the conduit may include introducing the second fluid in the same direction of flow as the constrained phase. Alternatively, the step of introducing the second fluid into the conduit may involve introducing the second fluid in the opposite direction of flow as the constrained phase. In either case, the method may, in some embodiments, include supplying the first fluid into the conduit at least while continuing to supply the second fluid into the conduit. In other embodiments, the constrained phase may be substantially immobilized on the plurality of fibers. In some cases, the step of introducing the mixture of chemical substances into the conduit comprises combining the mixture of chemical substances with the first and second fluids exterior to the conduit and subsequently introducing the combination into the conduit.

Apparatuses are provided which include a conduit with a fluid inlet proximate one end of the conduit and one fluid outlet proximate an opposing end of the conduit. The apparatuses further include a supply pipe coupled to the fluid inlet and a sample injection mechanism operatively associated with the supply pipe for selectively inserting an analytical or preparative chromatography mixture into a fluid in the supply pipe. Moreover, the apparatuses include a collection chamber positioned proximate the fluid outlet of the conduit and a plurality of fibers positioned longitudinally within the conduit and extending into the collection chamber. In some cases, the conduit may further include an additional fluid outlet proximate the opposing end of the conduit and/or an additional fluid inlet proximate the one end of the conduit. In alternative embodiments, the conduit may further include an additional fluid inlet proximate the opposing end of the conduit and/or an additional fluid outlet proximate the one end of the conduit. In some cases, one end of the plurality of fibers may be bundled into a tube and, in other cases; both ends of the plurality of fibers may be bundled into respective tubes. In any case, the apparatus may include a chromatography detector coupled to the fluid outlet and, in some particular embodiments, a chromatography fraction collector coupled to the chromatography detector.

In addition, apparatuses are provided which include a conduit with two fluid inlets respectively arranged proximate opposing ends of the conduit and two fluid outlets respectively arranged proximate the opposing ends of the conduit. The apparatuses further include a plurality of fibers positioned longitudinally within the conduit such that opposing ends of the plurality of fibers are respectively proximate the opposing ends of the conduit, wherein the opposing ends of the plurality of fibers are respectively bundled into one of the fluid inlets and one of the fluid outlets. The portions of plurality of fibers between the opposing bundled ends are sufficiently slack such that larger spaces exist between individual fibers along the portions of the plurality of fibers than spaces between the individual fibers at the opposing bundled ends. In some cases, the apparatuses may further include a supply pipe coupled to one of the two fluid inlets and a sample injection mechanism operatively associated with the supply pipe for selectively inserting an analytical or preparative chromatography mixture into a fluid in the supply pipe. In any case, the apparatus may include a chromatography detector coupled to the fluid outlet and, in some particular embodiments, a chromatography fraction collector coupled to the chromatography detector.

Moreover, apparatuses are provided which include a conduit with a fluid inlet proximate one end of the conduit and one fluid outlet proximate an opposing end of the conduit. The apparatuses further include a collection chamber positioned proximate the fluid outlet of the conduit, a plurality of fibers positioned longitudinally within the conduit and extending into the collection chamber, and a chromatography detector coupled to the fluid outlet. In some cases, a chromatography fraction collector coupled to the chromatography detector.

It will be appreciated to those skilled in the art having the benefit of this disclosure that this invention is believed to provide fiber conduit reactors/contactors and methods for performing chromatographic processes in such reactors/contactors. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims. The terms “approximately” and “about”, as used herein, refers to variations of up to +/−5% of the stated number.

What is claimed:

1. A method for conducting chromatographic separations, comprising:
introducing a first fluid onto exterior surfaces of a plurality of fibers arranged longitudinally between opposing ends of a conduit such that at least some components of the first fluid constitute a phase substantially constrained to the exterior surfaces of the plurality fibers;
introducing a second fluid into the conduit proximate the plurality of fibers such that the second fluid constitutes a phase flowing in alignment and between the plurality of fibers with the constrained phase thereon, wherein the flowing phase is immiscible with the constrained phase;
introducing a mixture of chemical substances into the conduit proximate the plurality fibers subsequent to introducing the second fluid into the conduit and while continuing to supply the second fluid into the conduit, wherein the chemical substances have different distribution coefficients relative to the constrained phase and the flowing phase, and wherein the flowing phase moves the chemical substances along the constrained phase of the plurality of fibers at respectively different speeds; and
routing the flowing phase from the conduit to a chromatography detector.

2. The method of claim 1, further comprising establishing a hydrodynamic equilibrium between the constrained phase and the flowing phase prior to introducing the mixture of chemical substances into the conduit.

3. The method of claim 1, wherein the step of introducing the mixture of chemical substances into the conduit comprises injecting the mixture of chemical substances into a fluid inlet supplying the second fluid into the conduit.

4. The method of claim 1, wherein the constrained phase flows along the plurality of fibers.

5. The method of claim 4, wherein the step of introducing the second fluid into the conduit comprises introducing the second fluid in the same direction of flow as the constrained phase.

6. The method of claim 4, wherein the step of introducing the second fluid into the conduit comprises introducing the second fluid in the opposite direction of flow as the constrained phase.

7. The method of claim 4, wherein the method further comprises supplying the first fluid into the conduit at least while continuing to supply the second fluid into the conduit.

8. The method of claim 7, wherein the step of introducing the mixture of chemical substances into the conduit comprises injecting the mixture of chemical substances into a fluid inlet supplying the first fluid into the conduit.

9. The method of claim 1, wherein the constrained phase is substantially immobilized on the plurality of fibers.

10. The method of claim 1, wherein the step of introducing the mixture of chemical substances into the conduit comprises combining the mixture of chemical substances with the first and second fluids exterior to the conduit and subsequently introducing the combination into the conduit.

11. An apparatus, comprising:
a conduit comprising:
a fluid inlet proximate one end of the conduit; and
one fluid outlet proximate an opposing end of the conduit;
a supply pipe coupled to the fluid inlet;
a sample injection mechanism operatively associated with the supply pipe for selectively inserting an analytical or preparative chromatography mixture into a fluid in the supply pipe;
a collection chamber positioned proximate the fluid outlet; and
a plurality of fibers positioned longitudinally within the conduit and extending into the collection chamber.

12. The apparatus of claim 11, wherein the conduit further comprises an additional fluid outlet proximate the opposing end of the conduit.

13. The apparatus of claim 11, wherein the conduit further comprises an additional fluid inlet proximate the one end of the conduit.

14. The apparatus of claim 11, wherein the conduit further comprises:
additional fluid inlet proximate the opposing end of the conduit; and
an additional fluid outlet proximate the one end of the conduit.

15. The apparatus of claim 11, wherein one end of the plurality of fibers is bundled into a tube.

16. The apparatus of claim 11, wherein both ends of the plurality of fibers are bundled into respective tubes.

17. The apparatus of claim 11, further comprising a chromatography detector coupled to the fluid outlet.

18. The apparatus of claim 17, further comprising a chromatography fraction collector coupled to the chromatography detector.

19. The apparatus of claim 11, wherein the fibers comprise random directional fibers.

20. An apparatus, comprising:
a conduit comprising:
two fluid inlets respectively arranged proximate opposing ends of the conduit; and
two fluid outlets respectively arranged proximate the opposing ends of the conduit; and
a plurality of fibers positioned longitudinally within the conduit such that opposing ends of the plurality of fibers are respectively proximate the opposing ends of the conduit, wherein the opposing ends of the plurality of fibers are respectively bundled into one of the fluid inlets and one of the fluid outlets, and wherein portions of plurality of fibers between the opposing bundled ends are sufficiently slack such that larger spaces exist between individual fibers along the portions of the plurality of fibers than spaces between the individual fibers at the opposing bundled ends.

21. The apparatus of claim 20, further comprising:
a supply pipe coupled to one of the two fluid inlets; and
a sample injection mechanism operatively associated with the supply pipe for selectively inserting an analytical or preparative chromatography mixture into a fluid in the supply pipe.

22. The apparatus of claim 20, further comprising a chromatography detector coupled to the fluid outlet.

23. The apparatus of claim 22, further comprising a chromatography fraction collector coupled to the chromatography detector.
